(19) United States
(12) Patent Application Publication
(10) Pub. No.: US 2011/0040707 A1
(43) Pub. Date: Feb. 17, 2011

(54) INTELLIGENT MUSIC SELECTION IN VEHICLES

(75) Inventors: Kacie Alane Theisen, Novi, MI (US); Oleg Yurievitch Gusikhin, West Bloomfield, MI (US); Perry Robinson MacNeille, Lathrup Village, MI (US); Dimitar Petrov Filev, Novi, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/539,743

(22) Filed: Aug. 12, 2009

(51) Int. Cl. G06F 15/18; G06N 5/02; G06F 3/048

(52) U.S. Cl. 706/12; 715/704; 706/46

(57) ABSTRACT

A method of intelligent music selection in a vehicle includes learning user preferences for music selection in the vehicle corresponding to a plurality of driving conditions of the vehicle. Input is received that is indicative of a current driving condition of the vehicle. And, music is selected and played based on the learned user preferences for music selection in the vehicle corresponding to the current driving condition.

### BACKGROUND

1. Technical Field

The invention relates to intelligent music selection in vehicles based on user preferences and driving conditions.

2. Background Art

Historically, major audio technology has migrated from the domestic market to the automotive market. Examples are AM radio, FM radio, Stereo, Compact Disks, etc. The latest trend in domestic audio is Internet radio, which transforms the broadcast industry.

Listening to music on the radio while driving is common practice for drivers in the United States; however, this can become a safety concern when a driver's attention is diverted from the road to the radio controls. Since traditional radio stations play music for commercial purposes, listeners may find themselves frequently changing stations to search for a song that fits their preferences. In addition, it has long been known that tempo can influence a listener's actions. Consequently, drivers subconsciously increase their driving speed due to the increased tempo of their music. Correlating a user's preferences and driving conditions with the parameters of the music being played would result in safer driving on the road.

The vehicle radio has evolved in recent years into a complex media center. Each occupant of the vehicle may have individual controls and the sources of media are much larger and more diverse. The driver is presented with many more choices as compared to the past. Choosing between 400 channels on a satellite radio using conventional controls is a daunting task that increases the driver's cognitive load and is thus a distraction from more important tasks.

In addition to being a distraction, operating the radio requires cognitive effort which is fatiguing and impairs the driving experience. On the other hand, occupants have little control of their environment while driving, and the radio traditionally has served as an element that they could control. Therefore, an interface is needed for the occupants to exert control over what is played on the media center that does not overwhelm them with choices.

Another problem with modern media centers is they are patterned after the needs of home entertainment systems and are not convenient for in vehicle use. They are typically broken down into a number of units such as a radio, DVD/CD player, mp3 player, etc. So they compete for space on the dashboard and for the occupant's attention with other conventional controls that are becoming equally complex. Methods are needed to consolidate these controls and to make them more compact while maintaining ease of use. As a result, new methods of controlling the radio and reducing a driver's cognitive load are needed.

Background information may be found in U.S. Pat. No. 7,003,515 and U.S. Pub. Nos. 2006/0107822, 2007/0169614, and 2008/0269958. Further background information may be found in “CES09: Gracenote gives you a talking celebrity music guide,” SFGate, San Francisco Chronicle, Jan. 9, 2009.

### SUMMARY

In one embodiment, the invention comprehends a method of intelligent music selection in a vehicle. The method comprises learning user preferences for music selection in the vehicle corresponding to a plurality of driving conditions of the vehicle. Input is received that is indicative of a current driving condition of the vehicle. And, music is selected based on the learned user preferences for music selection in the vehicle corresponding to the current driving condition. The method further comprises playing the selected music.

At the more detailed level, the invention comprehends various additional features that may be incorporated into embodiments of the invention. In one feature, the vehicle includes a natural language interface, and learning user preferences further comprises receiving input indicative of user preferences in the form of natural language received through the natural language interface. In another feature, the vehicle includes an emotion recognition system, and learning user preferences further comprises processing received natural language with the emotion recognition system to determine user preferences. In another feature, the vehicle includes an emotive advisory system which includes the natural language interface and which interacts with the user by utilizing audible natural language and a visually displayed avatar. Visual and audible output is provided to the user by outputting data representing the avatar for visual display and data representing a statement for the avatar for audio play.

Embodiments of the invention may incorporate various additional features relating to the way music is selected. For example, selecting music may include selecting a music station based on the learned user preferences, and utilizing a recommender system to select music based on the selected music station. In a recommender system, specific features of a unit of music are identified and stored in a database. Users develop their own informational filter by listening to music and telling the system whether they like it or not. The system identifies the features the user likes and refines its choices based on the history of responses from the user. The priority and satisfaction with each feature is stored in a user profile. Each Internet radio station has its own user profile, and a single user may have several stations. It is up to the user to choose a station that fits his/her current preferences Music may also be selected based on an active collaborative filtering system that further refines the music selection based on an affinity group whose members vote for their favorite music. Music that receives the most votes is played more frequently to members of the group. Each affinity group is called a “station.” Music may be selected further based on a context awareness system that further refines the music selection based on context.

In another embodiment, the invention comprehends a method of intelligent music selection in a vehicle comprising receiving input indicative of a current driving condition of the vehicle; and establishing a discrete dynamic system having a state vector and receiving an input vector. The state vector represents a current music selection. The input vector represents the current driving condition of the vehicle. The discrete dynamic system operates to predict a next music selection according to a probabilistic state transition model representing user preferences for music selection in the vehicle corresponding to a plurality of driving conditions of the vehicle.

The method further comprises predicting the next music selection with the discrete dynamic system. Music is selected based on the predicted next music selection, and the selected music is played.

At the more detailed level, the method may include the additional actions of learning user preferences for music selection in the vehicle corresponding to the plurality of driving conditions of the vehicle, and establishing the probabilistic state transition model based on the learned user preferences.

In another embodiment, the invention comprehends a system for intelligent music selection in a vehicle. The system comprises a music artificial intelligence module for selecting music and a context aware music player (CAMP) configured to play the selected music. The music artificial intelligence module is configured to learn specified user preferences for music selection in the vehicle corresponding to a plurality of driving conditions of the vehicle, to receive input indicative of a current driving condition of the vehicle, and to select music based on the learned user preferences for music selection in the vehicle corresponding to the current driving condition.

At the more detailed level, the context aware music player may be further configured to play music in accordance with user commands. In turn, the music artificial intelligence module is operable in a learning mode in which the music artificial intelligence module learns user preferences for music selection in the vehicle corresponding to the plurality of driving conditions in accordance with the music played in response to the user commands. Further, the music artificial intelligence module may then operate in a prediction mode in which the music artificial intelligence module selects music based on the learned user preferences.

### BRIEF DESCRIPTION OF THE DRAWINGS

FIG. 1 is a block diagram of an emotive advisory system for an automotive vehicle, in one embodiment;

FIG. 2 is a block diagram of an emotive advisory system for an automotive vehicle, including a context aware music player and music artificial intelligence (AI) module, in one embodiment;

FIG. 3 illustrates a model of the music artificial intelligence (AI) module in one embodiment;

FIG. 4 illustrates a transition probability matrix for the music AI module;

FIG. 5 is a block diagram illustrating a method of intelligent music selection in one embodiment of the invention;

FIG. 6 is a block diagram illustrating further more detailed aspects of a method of intelligent music selection;

FIG. 7 is a block diagram illustrating further more detailed aspects of a method of intelligent music selection; and

FIG. 8 is a block diagram illustrating a method of intelligent music selection in another embodiment of the invention.

### DETAILED DESCRIPTION

Embodiments of the invention comprehend intelligent music selection in vehicles based on user preferences and driving conditions. In one approach to implementing the intelligent music selection, various media interfaces in an automotive vehicle are consolidated into a single interface in an emotive advisory system (EAS). It is appreciated that embodiments of the invention are not limited to automotive vehicles or to emotive advisory systems.

In general, the emotive advisory system (EAS) for the automotive vehicle emotively conveys information to an occupant. The system receives input indicative of an operating state of the vehicle, transforms the input into data representing a simulated emotional state and generates data representing an avatar that expresses the simulated emotional state. The avatar may be displayed. The system may receive a query from the occupant regarding the emotional state of the avatar, and respond to the query. An example emotive advisory system and method is described in U.S. Pub. No. 2008/0269958.

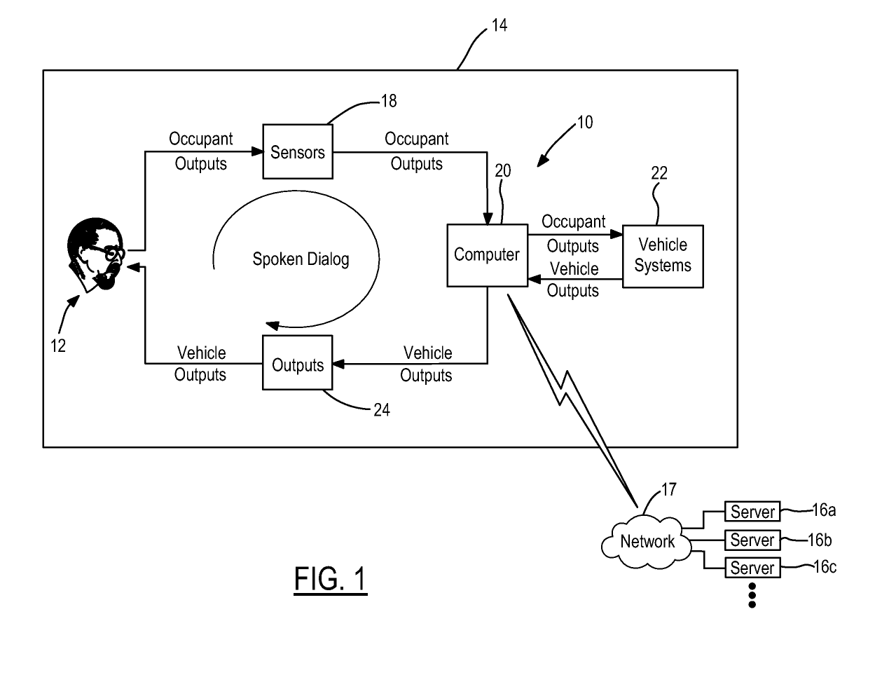

As shown in FIG. 1, an embodiment of an emotive advisory system (EAS) 10 assists an occupant/user 12 of a vehicle 14 in operating the vehicle 14 and in accessing information sources 16a, 16b, 16c, for example, web servers, etc., remote from the vehicle 14 via a network 17. Of course, other embodiments of the EAS 10 may be implemented within the context of any type of device and/or machine. For example, the EAS 10 may accompany a household appliance, handheld computing device, etc. Certain embodiments of the EAS 10 may be implemented as an integrated module that may be docked with another device and/or machine. A user may thus carry their EAS 10 with them and use it to interface with devices and/or machines they wish to interact with. Other configurations and arrangements are also possible.

In the embodiment of FIG. 1, sensors 18 detect inputs generated by the occupant 12 and convert them into digital information for a computer 20. The computer 20 receives these inputs as well as inputs from the information sources 16a, 16b, 16c and vehicle systems 22. The computer 20 processes these inputs and generates outputs for at least one of the occupant 12, information sources 16a, 16b, 16c and vehicle systems 22. Actuators/outputs, etc. 24 convert the outputs for the occupant 12 from a digital format into a format that may be perceived by the occupant 12, whether visual, audible, tactile, haptic, etc.

The occupant 12 may, in some embodiments, communicate with the EAS 10 through spoken dialog that follows rules of discourse. For example, the occupant 12 may ask “Are there any good restaurants in the area?” In response, the EAS 10 may query appropriate information sources 16a, 16b, 16c and, together with geographic location information from the vehicle systems 22, determine a list of highly rated restaurants near the current location of the vehicle 14. The EAS 10 may answer with the simulated dialog: “There are a few. Would you like to hear the list?” An affirmative response from the occupant 12 may cause the EAS 10 to read the list.

The occupant 12 may also command the EAS 10 to alter certain parameters associated with the vehicle systems 22. For example, the occupant 12 may state “I feel like driving fast today.” In response, the EAS 10 may ask “Would you like the drivetrain optimized for performance driving?” An affirmative response from the occupant 12 may cause the EAS 10 to alter engine tuning parameters for enhanced performance.

In some embodiments, the spoken dialog with the EAS 10 may be initiated without pressing any buttons or otherwise physically providing input to the EAS 10. This open microphone functionality allows the occupant 12 to initiate a conversation with the EAS 10 in the same way the occupant 12 would initiate a conversation with another occupant of the vehicle 14.

The occupant 12 may also “barge in” on the EAS 10 while it is speaking. For example, while the EAS 10 is reading the list of restaurants mentioned above, the occupant 12 may interject “Tell me more about restaurant X.” In response, the EAS 10 may cease reading the list and query appropriate information sources 16a, 16b, 16c to gather additional information regarding restaurant X. The EAS 10 may then read the additional information to the occupant 12.

In some embodiments, the actuators/outputs 24 include a screen that selectively displays an avatar. The avatar may be a graphical representation of human, animal, machine, plant, vehicle, etc. and may include features, for example, a face, etc., that are capable of visually conveying emotion. The avatar may be hidden from view if, for example, a speed of the vehicle 14 is greater than a threshold which may be manufacturer or user defined. The avatar's voice, however, may continue to be heard. Of course, any suitable type of display technology, such as a holographic or head-up display, may be used.

The avatar's simulated human emotional state may depend on a variety of different criteria including an estimated emotional state of the occupant 12, a condition of the vehicle 14 and/or a quality with which the EAS 10 is performing a task, etc. For example, the sensors 18 may detect head movements, speech prosody, biometric information, etc. of the occupant 12 that, when processed by the computer 20, indicate that the occupant 12 is angry. In one example response, the EAS 10 may limit or discontinue dialog that it initiates with the occupant 12 while the occupant 12 is angry. In another example response, the avatar may be rendered in blue color tones with a concerned facial expression and ask in a calm voice “Is something bothering you?” If the occupant 12 responds by saying “Because of this traffic, I think I'm going to be late for work,” the avatar may ask “Would you like me to find a faster route?” or “Is there someone you would like me to call?” If the occupant 12 responds by saying “No. This is the only way . . . , ” the avatar may ask “Would you like to hear some classical music?” The occupant 12 may answer “No. But could you tell me about the upcoming elections?” In response, the EAS 10 may query the appropriate information sources 16a, 16b, 16c to gather the current news regarding the elections. During the query, if the communication link with the information sources 16a, 16b, 16c is strong, the avatar may appear happy. If, however, the communication link with the information sources 16a, 16b, 16c is weak, the avatar may appear sad, prompting the occupant to ask “Are you having difficulty getting news on the elections?” The avatar may answer “Yes, I'm having trouble establishing a remote communication link.”

During the above exchange, the avatar may appear to become frustrated if, for example, the vehicle 14 experiences frequent acceleration and deceleration or otherwise harsh handling. This change in simulated emotion may prompt the occupant 14 to ask “What's wrong?” The avatar may answer “Your driving is hurting my fuel efficiency. You might want to cut down on the frequent acceleration and deceleration.” The avatar may also appear to become confused if, for example, the avatar does not understand a command or query from the occupant 14. This type of dialog may continue with the avatar dynamically altering its simulated emotional state via its appearance, expression, tone of voice, word choice, etc. to convey information to the occupant 12.

The EAS 10 may also learn to anticipate requests, commands and/or preferences of the occupant 12 based on a history of interaction between the occupant 12 and the EAS 10. For example, the EAS 10 may learn that the occupant 12 prefers a cabin temperature of 72 Fahrenheit when ambient temperatures exceed 80 Fahrenheit and a cabin temperature of 78 Fahrenheit when ambient temperatures are less than 40° Fahrenheit and it is a cloudy day. A record of such climate control settings and ambient temperatures may inform the EAS 10 as to this apparent preference of the occupant 12. Similarly, the EAS 10 may learn that the occupant 12 prefers to listen to local traffic reports upon vehicle start-up. A record of several requests for traffic news following vehicle start-up may prompt the EAS 10 to gather such information upon vehicle start-up and ask the occupant 12 whether they would like to hear the local traffic. Other learned behaviors are also possible.

These learned requests, commands and/or preferences may be supplemented and/or initialized with occupant-defined criteria. For example, the occupant 12 may inform the EAS 10 that it does not like to discuss sports but does like to discuss music, etc. In this example, the EAS 10 may refrain from initiating conversations with the occupant 12 regarding sports but periodically talk with the occupant 12 about music.

It is appreciated that an emotive advisory system (EAS) may be implemented in a variety of ways, and that the description herein is exemplary. Further more detailed description of an example emotive advisory system is provided in U.S. Pub. No. 2008/0269958. In general, with continuing reference to FIG. 1, computer 20 communicates with information sources 16a, 16b, 16c, and communicates with various peripheral devices such as buttons, a video camera, a vehicle BUS controller, a sound device and a private vehicle network. The computer 20 also communicates with a display on which the avatar may be rendered. Other configurations and arrangements are, of course, also possible.

An exemplary embodiment of the invention for intelligent music selection in vehicles based on user preferences and driving conditions consolidates the various media interfaces in the automotive vehicle into a single interface in EAS 10. EAS 10 would then act as a digital media center, but with a natural language interface and an avatar suitable for vehicle use. In this way, only one device is needed to select media on satellite radio, Internet radio, conventional radio, television, Internet video, mp3 and video player, DVD/CD player, etc. instead of having a separate interface for each device. This saves space on the dashboard, reduces clutter in the passenger compartment and means only one interface needs to be understood by the vehicle occupants to control the entire system.

At the more detailed level, embodiments of the invention comprehend various features which may be implemented individually or in combinations, depending on the application.

According to one contemplated feature, EAS 10, which serves as the common interface, also has an information filtering system called a recommender system that helps the occupants choose the media they wish to play. Recommender systems are currently the subject of considerable research, and it is appreciated that the implementation of such a recommender system may take various forms. With this system the occupant can specify a set of examples of music they would like to hear using ands and ors. For example, the occupant might say in natural language (because it is implemented under EAS 10) “I would like to hear something like Billy Joel (piano man), Janis Joplin or Joe Cocker, but not like King Crimson or Henri Mancini.” This would cause the system to select a song outside the set the occupant has specified but still similar to the songs the occupant likes and dissimilar to the ones the occupant does not.

An example of recommender systems is found in Internet radio services that are becoming increasingly popular due to a user's ability to set up their musical preferences and have the songs played tailored to their specifications. When a user signs onto an Internet radio site for the first time they are asked to select an artist or genre of music they would like to listen to. At this point a play list is created and as a user listens they can provide some form of feedback to indicate they like or do not like a particular song. Each song a user likes or does not like can be broken down into several parameters. In particular, U.S. Pat. No. 7,003,515 discusses one algorithm for identifying and classifying the characteristics of a song; however, there are several software packages available to do this. As historical information accumulates for a user, specific parameters of the listener's musical likes and dislikes can be compiled. The Internet radio station can use this information to select which songs to play. An Internet radio station is actually an informational filter that automatically selects music customized for a specific user. Two kinds of informational filters are collaborative filters and recommender systems. This is in contrast to a physical broadcasting station. With Internet radio, selection is done with a configurable informational filter that is configured by the end user of the content, rather than experts in a radio station or media outlet.

Frequently, when an occupant plays a media selection, the system asks if the occupant is satisfied with the song and why or why not using the EAS natural language interface. It also uses EAS 10 to assess the occupant's state to determine if the media was favorably received by the occupant. This helps the recommender system further refine the selection of media, so the system learns the user's preferences. Historical information about an occupant's choices is used to train the recommender system so that over time it learns each occupant's preferences.

The system may also be able to detect changes in the user's preferences over time using real-time clustering methods related to statistical process control. These changes can be used by EAS 10 to estimate the driver's emotions (rapid change), mood (slower change), tendencies (typical driver states), personality (very long term state), gender (music may have a gender bias), ethnicity (ethnocentric music choices), etc. This information is used by EAS 10 to determine the mode of interaction between EAS 10 and the occupants. In another example, EAS 10 may estimate the driver's age (period of music). In more detail, this is really not just age. It is the music people learned during formative years between approximately 14 and 22. The music would also depend on where the person lived and what they were exposed to.

The recommender system may also allow the occupant to define groupings of media that they may like at different times depending on factors such as mood, driving conditions, purpose of the journey, other occupants of the vehicle, etc. These choices may also be used by EAS 10 to determine the occupant's state.

According to another contemplated feature, an active collaborative filtering system could be added to EAS 10 that allows the user to further refine the media by affiliation group, such as political leaning, ethnic identity, geographical affinity, consumer choices, age, religion, work identification, company affiliation, etc. The collaborative filtering may be combined with the recommender system in an and, or, nor, not fashion, and relies on the preferences of self-organized groups on the world-wide web to select songs. Collaborative filters typically do not use features of the music. They rely exclusively on member's votes. For example one might subscribe to the Harvard Drinking Songs affinity group. Members of the group would recommend media they believe are consistent with the themes of the group to the group. This would be reinforced when multiple group members recommend the same song, or cancelled if many members do not support the media's inclusion in the group.

The media can be used to proactively set an appropriate mood for the vehicle when occupants are distracted from driving by interactions within the vehicle. Parents can use the system to limit teenage driver's access to certain music when driving. If the driver is distracted by strong emotion, media may be selected that sets a more appropriate and safer ambiance.

Active collaborative filtering systems have also been the subject of considerable research, and it is appreciated that the implementation of such an active collaborative filtering system may take various forms.

According to another contemplated feature, a third type of filter/search method that may be employed is context awareness. Context aware computing has also been the subject of considerable research, and it is appreciated that the implementation of context awareness may take various forms.

In the contemplated feature, information about the vehicle location, occupant state as determined by EAS 10, nearby points of interest, length of trip, time remaining in the trip, the state of the stock market, weather, topography, etc. is also used to refine the list of media that is selected. For example, EAS 10 will know the route the driver intends to take on a specific journey, speed of the vehicle, the likely duration of the trip, where the driver may need to stop for fuel, etc. from the navigation system. This information may be used to design a dynamic play list for the entire journey that will anticipate the occupants media needs and provide the media as needed.

Embodiments of the invention which consolidate various media interfaces into a single interface in EAS 10 address the problem of frustrated drivers who cannot find the media they want in the vehicle, by presenting the occupants with an easy to use spoken language interface. The user will be able to voice opinions regarding the choice of music to build up their profile by saying phrases like “Next song,” “I don't like this artist,” or “I like this song.” These spoken commands will then be transmitted back to a server where the user's preferences can be updated in addition to taking action to change the song being played if the user does not like it. The speech recognition software can be hooked up with emotion recognition software which will allow analysis of what the listener is saying to extract their emotional connection. For instance they can say “Next” neutrally indicating they might like the song but just do not want to listen to it right now, or they could say “Next” angrily indicating they do not like the song and don't want to hear it again. This can aid in building up the user's preferences quickly.

Research has suggested that there is a positive correlation between driving speeds and music tempo. In addition to incorporating a user's preferences into the selection of the next song, the system could also incorporate the current driving conditions. Determination of the driver's current speed can be obtained from the vehicle CAN Bus. In addition, the posted speed limit of the road can be determined from navigation devices or websites. If it is determined that the driver is speeding, the next song chosen can be one with a slower tempo to encourage the driver to slow down. In addition, sensors on the exterior of the vehicle or information on current traffic conditions can be used to determine if the user is stuck in a traffic jam and if so the music selected will have slower tempos. If it is determined that the road is not congested and the driver is going less than the speed limit then the next song chosen may have a slightly faster tempo. Time of day can also be used to determine which music should be played next, perhaps earlier in the morning an upbeat music would be played to help a listener wake up and get going with their day. Really late at night, upbeat music may also be selected to help prevent the driver from falling asleep at the wheel.

There are several advantages to embodiments of the invention which intelligently choose the next song to be played based on the user's preferences and the current driving conditions. By playing songs a listener enjoys and including a spoken interaction with the radio, the time spent playing with the radio controls is minimized and consequently so is the time when the driver's attention is diverted from the road. Incorporating the current driving conditions into the selection of the next song to be played could also aid in safe driving practices. Another advantage is the ability to personalize the radio for each individual driver.

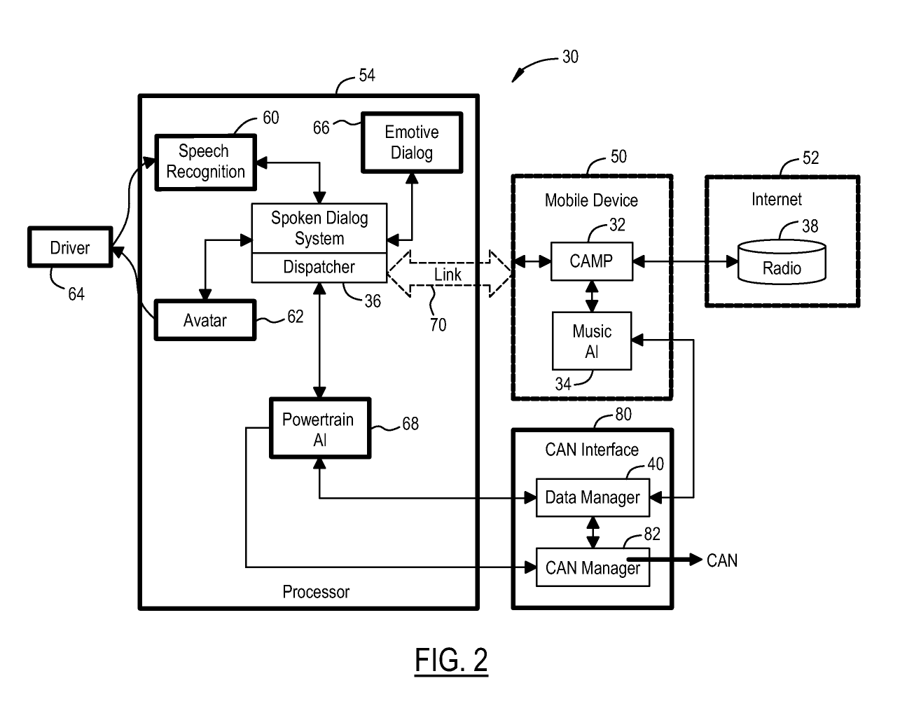

FIG. 2 illustrates a block diagram of an emotive advisory system (EAS) 30 for an automotive vehicle. EAS 30 is illustrated at a more detailed level, and includes a context aware music player (CAMP) 32 and music artificial intelligence (AI) module 34 to implement several contemplated features. EAS 30 of FIG. 2 may operate generally in the same manner described above for EAS 10 of FIG. 1. Further, it is appreciated that CAMP 32 and music AI module 34 are one possible way to implement contemplated features. Other implementations are possible.

The context aware music player (CAMP) 32 is an informational filter that controls the flow of sound from Internet sources into the vehicle speakers. CAMP 32 accepts channel selections and proactive commands from the music AI module 34 and instructions from spoken dialog system/dispatcher 36. Proactive commands are forwarded to the spoken dialog system 36 and returned as commands modified by the driver interaction through the spoken dialog system 36.

CAMP 32 accepts commands from the dispatcher 36 and music AI 34, and receives data from an Internet radio system 38 (for example, PANDORA Internet radio, Pandora Media, Inc., Oakland, Calif.; Rhapsody, RealNetworks, Inc., Seattle, Wash.). Music AI 34 outputs a status message to the data manager 40, and CAMP 32 plays music on the vehicle sound system over a Bluetooth connection.

Embodiments of the invention may provide a personalized context aware music player (CAMP) that implements explicit occupant preferences as well as discovered occupant preferences in the music selection process. Advantageously, this may overcome the paradox of choice in which the driver is overwhelmed with the number of music selections, and may provide media content without fees or subscriptions. The music selection process may be source agnostic, not depending on any particular Internet radio system. Advantageously, the driving experience may be improved by automatically selecting the right songs for the right occasion.

With continuing reference to FIG. 2, in this embodiment, the context aware music player (CAMP) 32 and music AI 34 are implemented on a mobile device 50. Mobile device 50 may take the form of any suitable device as is appreciated by those skilled in the art, and communicates over link 70 with the spoken dialog system/dispatcher 36. For example, mobile device 50 may take the form of a mobile telephone or PDA. In one implementation, ARM Hardware (ARM Holdings, Cambridge, England, UK) and Windows Mobile operating system (Microsoft Corporation, Redmond, Wash.) are used. Internet radio 38 is shown located on the Internet 52. Additional components of EAS 30 are implemented at processor 54. Processor 54 may take the form of any suitable device as appreciated by those skilled in the art. For example, processor 54 may be implemented as a control module on the vehicle. In more detail, additional components of EAS 30 are implemented by processor 54. As shown, spoken dialog system/dispatcher 36 communicates with speech recognition component 60 and avatar component 62, which interface with the driver 64. As well, spoken dialog system/dispatcher 36 also communicates with emotive dialog component 66. Finally, powertrain AI 68 communicates with spoken dialog system/dispatcher 36, and with CAN interface 80, which is composed of data manager 40 and CAN manager 82. These various components of EAS 30 may operate as described previously.

In the illustrated embodiment in FIG. 2, the system will have two modes of operation: learning mode and DJ mode. The learning mode is the default mode. In the learning mode, the stations are changed by the user while the music AI 34 observes and learns from the user selections.

More specifically, Internet radio 38 makes a plurality of stations available for listening. CAMP 32 acts as an interface from EAS 30 to the Internet radio 38. That is, Internet radio 38 is responsible for providing the various stations, and CAMP 32 provides the interface to Internet radio 38 such that a station may be selected. For example, Internet radio 38 may provide a custom classical music station, a custom hard rock station, etc. CAMP 32 will then select a station from these customized stations. In the learning mode, CAMP 32 does this under the direction of the user.

In the learning mode, the stations are changed by the user while the music AI 34 observes and learns from the user selections with the only exception being when the user asks for another station without specifying the exact name of the station. In this case, the music AI 34 will select the appropriate station.

In addition to providing a plurality of stations for selection, Internet radio 38 allows these stations themselves to be customized for the user. That is, for a particular station being played from Internet radio 38, Internet radio 38 accepts feedback from the user such that the particular station can be customized. For the example noted above, the Internet radio 38 may provide a custom classical music station. This station plays only classical music. As well, when the user is tuned to the classical music station, feedback from the user such as: I like this song (“thumbs up”), I don't like this song (“thumbs down”) allows Internet radio 38 to further customize the station. Put another way, the Internet radio 38 provides a plurality of music or information stations, with all or some of these stations being customized for the user based on user feedback. In turn, the CAMP 32 selects the desired station for the user/driver at a given time. In the learning mode, CAMP 32 makes the selection based on the driver's specific request.

In the DJ mode, the system automatically changes music stations based on the music AI 34. CAMP 32 selects the station for reception from Internet radio 38, with music AI 34 directing the station selection. This creates an intelligent shuffle like or DJ functionality. The user may of course, still explicitly select the station they would like to listen to. The music AI 34 will change the station based on the following three rules: (i) the user requested the station be changed; (ii) the user skips three songs in a row or votes “thumbs down” three times in a row; (iii) the music AI 34 changes the station based on the user's past preferences.

As explained above, CAMP 32 provides the interface to Internet radio 38. Internet radio 38 provides a plurality of stations, and receives feedback to allow customization of each station. Further, in operation, station selection is made by CAMP 32 either under the direction of the user, or by music AI 34. Communication among the user, music AI 34, CAMP 32, and Internet radio 38 allows the Internet radio 38 to continually refine the stations and allows music AI 34 to continually refine the logic and rules used to select the appropriate station based on user preferences and/or driving conditions.

In the illustrated embodiment, the music AI 34 will select stations based on learned user preferences with respect to the following parameters: current station, elapsed time at the current station (or number of songs), cognitive load, aggressiveness, vehicle speed, time of day. Of course, other variations are possible.

Interaction between the music AI 34 and CAMP 32 will include: user voted a song up/likes the song, and user changed the station including the new and old station. Of course, other variations are possible.

Users can give feedback on the station by choosing to listen to the selected station, changing the station, and voting thumbs up or thumbs down for individual songs. If the user listens to the end of the song (does not change the station) and/or votes “thumbs up” for the song it will be sent to the music AI 34 as “positive” feedback regarding the station selection. Negative feedback will be indicated by a lack of positive feedback and by the event that the station is changed. Negative feedback regarding song choices will be sent to the Internet radio server 38 to refine the selected station. Again, other variations are possible.

In the illustrated embodiment, the command sequence for commands (and dialogue) from the user generally includes a command sent from the user to the spoken dialog system (SDS) 36, and on to CAMP 32 from SDS 36, and as appropriate, on to Internet radio 38. In general, commands may be spoken by the driver and are converted into computer protocol by speech recognition. In the illustrated embodiment, the following commands (and dialogue) will be available for the user:
Turn the system on/off—command sent to both Internet radio 38 and CAMP 32.
Change to DJ mode (Turn DJ mode on/off.)—command sent to CAMP 32 to initiate automatic station recommendations using Music AI. The absence of this command indicates the system should be in learning mode.
Select/change station X—command sent to Internet radio 38 via CAMP 32.
Switch/change the (another) station—command sent to Internet radio 38 via CAMP 32.
Go to the next song/skip a song—command sent to Internet radio 38 via CAMP 32.
Vote “thumbs up”/I like the song—command sent to Internet radio 38 via CAMP 32.
Vote “thumbs down”/I don't like the song—command sent to Internet radio 38.
Ask the music AI 34 to select another station—command sent to the CAMP 32.
Song finished—this command will not be available for the user, but will be sent to CAMP 32.
Who is the artist?—command sent to Internet radio 38.
What is the name of the song?—command sent to Internet radio 38.
Turn announcements on/off−sent to CAMP 32.
Bookmark the song—command sent to Internet radio 38.

Further, in the illustrated embodiment, the intelligent music selection system will interact with the user through the avatar 62 available in EAS 30. The avatar's facial expressions should be mapped to the commands described above as follows:
Happy: I like the song/“thumbs up.”
Sad: I don't like the song/“thumbs down,” go to the next song/skip a song.
Disappointment: If a command/request is not understood, if there are problems or delays to play the song.
Satisfaction: When commands are executed (and requests are understood)—turn the system on/off, change to DJ mode, select/change station X, switch/change the (another) station.
Neutral: otherwise.

In the illustrated embodiment, if the current state is low cognitive load, announcements will be made regarding any problems or delays playing music or understanding a command/request.

With continuing reference to FIG. 2, in addition to the basic functionality described above, EAS 30 provides commands over link 70 for controlling CAMP 32. More particularly, EAS link commands for controlling CAMP 32 include: run, suspend, halt, resume, and signal (hup).

Spoken dialog system/dispatcher 36 and music AI 34 also provide commands for CAMP 32 relating to controlling the media player, track control, announcements, station selection, and turning DJ mode on and off. The commands for controlling the media player include: stop the media player, start the media player, pause the media player, resume the media player. The track control commands include: tell CAMP 32 the driver likes the track that is playing, tell CAMP 32 the driver dislikes the track that is playing, tell CAMP 32 to skip the current track, tell CAMP 32 to bookmark the current track. The commands relating to announcements include: tell CAMP 32 to turn off announcements, and tell CAMP 32 to turn on announcements. The station selection commands include a command for selecting a station. And, the DJ mode related commands include: DJ mode off, and DJ mode on.

With continuing reference to FIG. 2, CAMP 32 also provides a CAMP status global information message that is published in data manager 40 whenever a change of status occurs. The message is available globally, but is primarily needed by spoken dialog system/dispatcher 36 and music AI 34.

The following is a sample of the status message:

```
<?xml version=“1.0” encoding=“UTF-8”?>
    <campStatus
    playerStatus=“stopped”
    station=“stationXYZ”
    status=“normal”
    DJstatus=“true”
    executionStatus=“stopped”
    stationList=“String”
    xmlns=“camp”>
    <tractInformation
        album=“String”
        artist=“String”
        title=“String”
        label=“String”
        genre=“String”
        graphic=“http://www.ford.com”
        publicationDate=“String”
    />
</campStatus>
```

Possible values of the status attributes are enumerated below:
playerStatus: stopped, playing, paused, resume.
station: driver defined name in a string.
status: normal, warning, severe, fatal.
DJstatus: true, false.
executionStatus: stopped, running.
stationList: delimited list of all station names that can be selected.
tractInformation (tract information attributes are optional):
   album: album name in a string.
   artist: artist name in a string.
   title: title of the tract in a string.
   label: label that recorded the album/tract.
   genre: genre of the song as defined by CDDB database.
   graphic: URL of a graphic image.
   publicationDate: date the tract was published.

It is appreciated that EAS 30, including CAMP 32 and music AI 34, and including all described functionality, is only exemplary. As such, embodiments of the invention may take many forms, and other approaches may be taken to implement any one or more of the comprehended features and functionality for intelligent music selection.

In addition, music AI 34 has been described as directing CAMP 32 to make station selections, and as continually refining the logic and rules used to select the appropriate station based on user preferences and/or driving conditions. It is appreciated that there are many possible approaches to implementing music AI 34, or implementing some other form of intelligent music selection in accordance with one or more of the features comprehended by the invention.

The following description is for an example embodiment of music AI 34 for EAS 30.

Music AI 34 keeps track of the driver's music selections under different conditions and uses this information to provide automatic music selection corresponding to the summarized driver's preferences and to the current conditions. Music AI 34, in the example embodiment described herein, is based on a learning and reasoning algorithm that uses the Markov Chain (MC) probabilistic model. Music AI 34 communicates with Internet radio 38 (via CAMP 32) and the data manager 40 as shown in FIG. 2.

Music AI 34 resides in the mobile device 50, and requires flash memory for the driver's music choices. Required memory depends on the input selection and the number of stations. The default configuration requires less than 1 kB of memory.

Embodiments of the invention may have several advantages. Some embodiments may automatically summarize, learn, and store a driver's music preferences that are defined as stations (stations are usually associated with different musical styles). Some embodiments may identify a mapping that links the stations to certain predefined driving conditions, for example, time of the day, driving style, workload index, and average vehicle speed (assuming that such correlation exists). Some embodiments may enable automatic switching between the stations based on the identified relationships (DJ mode).

Further, some embodiments may automatically maintain and update the relationship between the stations and the driving conditions. Some embodiments may transfer information to other music applications that can structure the music selections in groups similar to the concept of stations.

Generally, music AI 34 is not responsible for learning music characteristics of the songs, mapping between the individual songs and driving conditions, or applications to other music devices that cannot be structured in groups that resemble the concept of a station that is used by Internet radio 38.

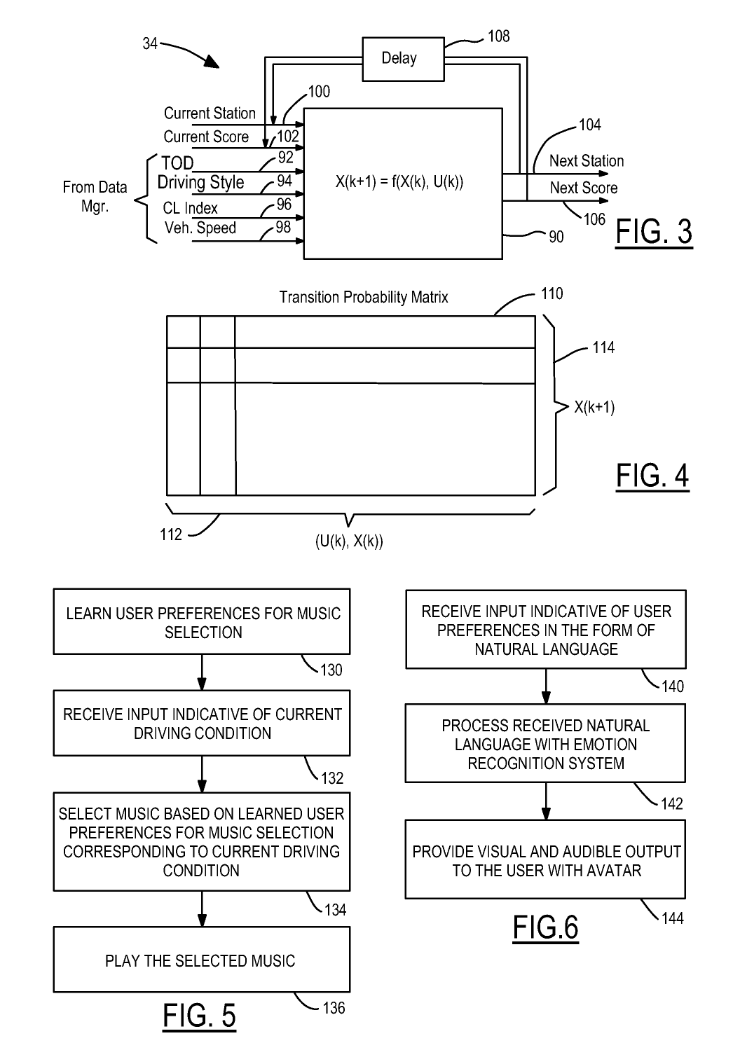

In more detail, in the illustrated embodiment, the music AI 34 works as a discrete dynamic system with a state vector X that is formed by the stations and input vector U that corresponds to the driving conditions. In a learning mode, music AI 34 continuously learns the relationships between the station selections and driving conditions and creates a model—a transition probability matrix representing a summary of those relationships. In a DJ mode, music AI 34 recognizes the conditions and the existing patterns of transitions between the current and the newly selected stations under those conditions, and provides a recommendation for the station selection. A model of music AI 34, in one embodiment, is shown in FIG. 3.

As shown in FIG. 3, music AI 34 includes block 90 representing the discrete dynamic system. The state vector X is a vector of all stations (discrete set of labels (‘1’, ‘2’, . . . )). The input vector U is composed from vectors of conditions (continuous, discretized in 2 intervals (TOD), 2 intervals (driving style)). The number of conditions may vary.

With continuing reference to FIG. 3, the discrete dynamic system (block 90) receives inputs from data manager 40 (FIG. 2), representing time of day 92, driving style 94, cognitive load index 96, and vehicle speed 98. As further shown, block 90 receives the current station 100 and current score 102 (described further below). Block 90 outputs the next station 104 and the next score 106, which are fed back through delay block 108 to the input side.

The music AI 34 algorithm covers three main scenarios: initialization, learning, and DJ (prediction).

Initialization is performed when:
The system is set up for the first time on the mobile device.
The maximal number of stations is changed.
The type and/or the number of parameters determining the driving conditions are changed.
When the intervals defining the Markov Chain states are changed.

The result of this phase is setting up the structure of the AI model—a transition probability Markov Chain matrix.

Initialization setup parameters are:
max_states—maximal number of stations (default max_states=5).
nr_inputs—number of driving conditions (default nr_inputs=2, TOD and DrivingStyle).
min_inputs—vector of lower input bounds (default [0 0]).
max_inputs—vector of upper input bounds (default [24 1]).
discr_inputs—length of equidistant intervals partitioning the inputs (default [12 0.5] for partitioning the TOD and DrivingStyle in 2 intervals each).

Initialization creates a blank Markov Chain transition probability matrix of size (default):

F=5X(5*2*2)

that stores the probabilities for transitions between the stations for different driving conditions, as shown in FIG. 4. In FIG. 4, the transition probability matrix is indicated at 110. Each column represents a current state and set of input conditions, as indicated at 112. Each row represents a next state, as indicated at 114.

Learning phase is executed at the completion of each song. The purpose is to associate the current driving conditions with the station and ranking of the song. The result is used to update the transition probability matrix that is used to estimate the driver's selections in a DJ mode.

After each song, music AI 34 receives the following data from CAMP 32: station, score, reset, vector of driving conditions (default [TOD DrivingStyle]):
Station is the number of the station that was played.
Score=1 indicates that the driver liked the song (voice recognized), that is, station selection was confirmed.
Score=0.8 indicates the song played but not confirmed (soft acceptance).
Score=0 indicates the selection was rejected (driver did not like the station selection for the current conditions). This selection is assigned zero probability in the model.
Reset=1 indicates a new station. The probabilities associated with the station that was replaced by the new station are reset to zero.

Music AI 34 creates the following input vectors for the learning algorithm:

xk=[PrevStation Station Score Reset]

uk−vector of driving conditions (default uk=[TOD DrivingStyle])

The output of the learning algorithm is the updated transition probability matrix F.

The DJ mode (prediction mode) is executed immediately after the learning mode. The output of the prediction mode is the predicted new station. If the last prediction was successful, Score>0.7, the music AI algorithm replaces the previous station with the current station:

PrevStation=Station

and uses it to predict the new station. Otherwise, the previous station remains unchanged and is used for another try to make a correct prediction. In both cases the input vector for the prediction algorithm is formally the same:

xpk=[PrevStation uk]

where uk is the vector of driving conditions.

The output of the prediction algorithm is the predicted station. This predicted station label is sent to CAMP 32.

Music AI 34 is designed to work with CAMP 32 when CAMP 32 is in a DJ mode with the station selection being driven by the music AI feature and the input from the driver is used to only reinforce/reject the recommended selection of station. It can also work with CAMP 32 when CAMP 32 is controlled by the driver. In this case, the learning algorithm uses driver's selections to update the transition probability model.

It is appreciated that the above description is an example embodiment. The music selection intelligence may take other forms. The example approach utilizes a transition probability matrix. Other approaches are possible. Further, the learning may be implemented in any suitable way, with some general details of one learning approach having been described above. Many learning algorithms are possible as appreciated by those skilled in the art of Markov Chain (MC) probabilistic models.

FIGS. 5-8 are block diagrams illustrating example methods of the invention. In FIG. 5, a block diagram illustrates a method of intelligent music selection in one embodiment of the invention. At block 130, user preferences for music selection in the vehicle corresponding to a plurality of driving conditions of the vehicle are learned. At block 132, input is received that is indicative of a current driving condition of the vehicle. At block 134, music is selected based on the learned user preferences for music selection in the vehicle corresponding to the current driving condition. At block 136, the selected music is played.

FIG. 6 illustrates further details of the method. When the vehicle includes a natural language interface, learning user preferences may include, as shown at block 140, receiving input indicative of user preferences in the form of natural language received through the natural language interface. Further, when the vehicle includes an emotion recognition system, learning user preferences may include, as shown at block 142, processing received natural language with the emotion recognition system to determine user preferences. Further, when the vehicle includes an emotive advisory system, as shown at block 144, visual and audible output is provided to the user by outputting data representing the avatar for visual display and data representing a statement for the avatar for audio play.

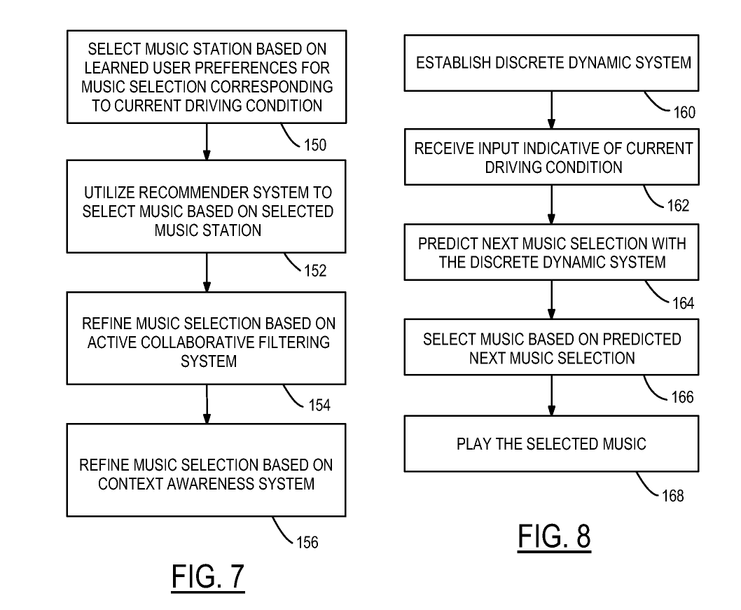

FIG. 7 illustrates further details of the method, and in particular, illustrates further details relating to music selection in some embodiments of the invention. At block 150, a music station is selected based on the learned user preferences for music selection in the vehicle corresponding to the current driving condition. Block 152 depicts utilizing a recommender system to select music based on the selected music station. Block 154 depicts refining the music selection based on an active collaborative filtering system that further refines the music selection based on affiliation group. Block 156 depicts refining the music selection based on a context awareness system that further refines the music selection based on context.

In FIG. 8, a block diagram illustrates a method of intelligent music selection in another embodiment of the invention. At block 160, a discrete dynamic system is established. At block 162, input is received that is indicative of a current driving condition of the vehicle. Block 164 depicts predicting the next music selection with the discrete dynamic system, and block 166 depicts selecting music based on the predicted next music selection. At block 168, the selected music is played.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method of intelligent music selection in a vehicle, the method comprising:
learning user preferences for music selection in the vehicle corresponding to a plurality of driving conditions of the vehicle;
receiving input indicative of a current driving condition of the vehicle;
selecting music based on the learned user preferences for music selection in the vehicle corresponding to the current driving condition; and
playing the selected music.

2. The method of claim 1 wherein the vehicle includes a natural language interface, and wherein learning user preferences further comprises:
receiving input indicative of user preferences in the form of natural language received through the natural language interface.

3. The method of claim 2 wherein the vehicle includes an emotion recognition system, and wherein learning user preferences further comprises:
processing received natural language with the emotion recognition system to determine user preferences.

4. The method of claim 2 wherein the vehicle includes an emotive advisory system which includes the natural language interface and which interacts with the user by utilizing audible natural language and a visually displayed avatar, and wherein learning user preferences further comprises:
providing visual and audible output to the user by outputting data representing the avatar for visual display and data representing a statement for the avatar for audio play.

5. The method of claim 1 wherein selecting music further comprises:
selecting a music station based on the learned user preferences for music selection in the vehicle corresponding to the current driving condition; and
utilizing a recommender system to select music based on the selected music station.

6. The method of claim 1 wherein selecting music further comprises:
selecting music based on the learned user preferences for music selection in the vehicle corresponding to the current driving condition, and further based on an active collaborative filtering system that further refines the music selection based on affiliation group.

7. The method of claim 1 wherein selecting music further comprises:
selecting music based on the learned user preferences for music selection in the vehicle corresponding to the current driving condition, and further based on a context awareness system that further refines the music selection based on context.

8. A method of intelligent music selection in a vehicle, the method comprising:
receiving input indicative of a current driving condition of the vehicle;
establishing a discrete dynamic system having a state vector and receiving an input vector, the state vector representing a current music selection, the input vector representing the current driving condition of the vehicle, the discrete dynamic system operating to predict a next music selection according to a probabilistic state transition model representing user preferences for music selection in the vehicle corresponding to a plurality of driving conditions of the vehicle;
predicting the next music selection with the discrete dynamic system;
selecting music based on the predicted next music selection; and
playing the selected music.

9. The method of claim 8 further comprising:
learning user preferences for music selection in the vehicle corresponding to the plurality of driving conditions of the vehicle; and
establishing the probabilistic state transition model based on the learned user preferences.

10. The method of claim 9 wherein the vehicle includes a natural language interface, and wherein learning user preferences further comprises:
receiving input indicative of user preferences in the form of natural language received through the natural language interface.

11. The method of claim 10 wherein the vehicle includes an emotion recognition system, and wherein learning user preferences further comprises:
processing received natural language with the emotion recognition system to determine user preferences.

12. The method of claim 10 wherein the vehicle includes an emotive advisory system which includes the natural language interface and which interacts with the user by utilizing audible natural language and a visually displayed avatar, and wherein learning user preferences further comprises:
providing visual and audible output to the user by outputting data representing the avatar for visual display and data representing a statement for the avatar for audio play.

13. The method of claim 8 wherein selecting music further comprises:
selecting a music station based on the predicted next music selection; and
utilizing a recommender system to select music based on the selected music station.

14. The method of claim 8 wherein selecting music further comprises:
selecting music based on the predicted next music selection, and further based on an active collaborative filtering system that further refines the music selection based on affiliation group.

15. The method of claim 8 wherein selecting music further comprises:
selecting music based on the predicted next music selection, and further based on a context awareness system that further refines the music selection based on context.

16. The method of claim 8 wherein establishing the discrete dynamic system further comprises:
configuring the discrete dynamic system based on a maximum specified number of music selections, and further based on monitored driving conditions.

17. A system for intelligent music selection in a vehicle, the system comprising:
a music artificial intelligence module configured to learn specified user preferences for music selection in the vehicle corresponding to a plurality of driving conditions of the vehicle, to receive input indicative of a current driving condition of the vehicle, and to select music based on the learned user preferences for music selection in the vehicle corresponding to the current driving condition; and
a context aware music player configured to play the selected music.

18. The system of claim 17 wherein the context aware music player is further configured to play music in accordance with user commands, and wherein the music artificial intelligence module is operable in a learning mode in which the music artificial intelligence module learns user preferences for music selection in the vehicle corresponding to the plurality of driving conditions in accordance with the music played in response to the user commands.

19. The system of claim 18 wherein the music artificial intelligence module is operable in a prediction mode in which the music artificial intelligence module selects music based on the learned user preferences.

20. The system of claim 17 further comprising:
a natural language interface for receiving input indicative of user preferences in the form of natural language.
